(19) United States
(12) Patent Application Publication
(10) Pub. No.: US 2020/0282505 A1
(43) Pub. Date: Sep. 10, 2020

(54) KIT OF PARTS INCLUDING A LASER GUIDE, CONDUIT BENDING SYSTEM AND METHODS THEREOF

(71) Applicant: Niklas D. Benton, Yuma, CO (US)

(72) Inventor: Niklas D. Benton, Yuma, CO (US)

(21) Appl. No.: 16/813,373

(22) Filed: Mar. 9, 2020

Related U.S. Application Data
(60) Provisional application No. 62/815,452, filed on Mar. 8, 2019.

(51) Int. Cl. B23Q 17/24; B21D 7/024

(52) U.S. Cl. CPC B23Q 17/2471; B21D 7/024

(57) ABSTRACT

A laser guided conduit bending system is provided for hand benders. The system comprises a curved bending head or shoe, and elongated handle attached with the shoe, a measuring system on the elongated handle and a magnetic laser pointer which is clamped or adhered with a conduit to be bent. The measuring system is incorporated onto the handle and provided with linear measurements. The magnetic laser pointer is attached to a conduit that references the conduits numerical and physical position to the measuring system for a conduit bending. Particularly, the system can be used for reducing time consumption in calculations for different offset angles and depths in the bending process and to give the user a physical alignment and a numerical unit value to any offset bend.

### FIELD OF INVENTION

The present invention generally relates to hand operated conduit, pipe or tube benders.

More particularly, a laser guided conduit bending system for offset type bends that reduces time consumption and calculations by providing physical guidance and alignment when performing all varieties of offset angles and depths in bending, shaping and forming process.

### BACKGROUND OF INVENTION

Manually operated tools for bending EMT conduit, pipe, or tube are quite old and well known in the art. Typical Electrical Metal Tubing (EMT) conduit is galvanized steel tubing having between a ½″ to 1″ diameter.

Conduit bending tools are widely used by electricians for forming bends in EMT conduit, through which electrical wires pass. The typical conduit benders include a curved forming head, which is sometimes referred to as a “shoe”. The curved head which receives the conduit, pipe, or tube that is to be formed.

In use, a conduit is inserted into the benders forming head so that the conduit forms along the curved bending surface of the head. Typically, the force required to make such bends is manual force, provided by the user by either applying pressure to the conduit towards the benders forming head, or by applying foot pressure to the benders foot peg and rotating the benders head against a hard-flat surface on the ground. This process is well known.

Bending tools can be found in U.S. Pat. Nos. 4,063,444, 5,934,132, 6,648,219B1, 6,920,700B2.

A bending tool is disclosed in U.S. Pat. No. 5,669,258, issued 23 Sep. 1997, and showing a mechanical tube bender angle indicator mountable on the handle of a manual tube bender. It includes a bubble level and a gauge for indicating angle of tube bend but has no indicia for indicating offset distances. The disclosure of this patent application is incorporated herein by reference.

U.S. Pat. No. 6,209,371, issued 3 Apr. 2001 discloses a tube bender having a bubble level and compass gauge for indicating angle of bend. No mechanism for indicating offset or distance is provided. The disclosure of this patent application is incorporated herein by reference.

A most common problem experienced by personnel using such tool to bend conduit is that it is often necessary to use varying bending angle degrees when performing offset type bends. Typically, the conduit/pipe/tube bender provides a legend of numerical multipliers associated with a specific bending angle to be used. These multiplier values are to be mathematically multiplied by the offset depth or height. These multiplier values often contain decimal fractions that are difficult to remember and compute without the use of a chart or calculator. The product of this multiplication calculation provides a numeric distance that is then transferred to the length of the conduit in order to obtain the two starting points of the two consecutive bends associated with an offset bend.

Another common problem with using such bending tool is that the conduit being formed requires marking of the conduit to reference the two starting points of the two consecutive bends that are made when performing an offset bend. These visual markings are often undesired when the conduit is exposed and not hidden behind walls. Many times, the markings have to be removed from the conduit to achieve a finished aesthetic appearance.

Another common problem with using such bending tool is the miss-alignment of the two consecutive bends made by the bender. This is also known to many as a “dogleg” in the conduit. After making an offset, the individual then lays the conduit along a flat and level surface to verify that the two bends are in-line and that the conduit lies flat and true to the surface. This alignment is important to an offset bend so that the conduit can be securely fastened to the desired surface. This alignment is also important to an offset bend so that the conduit continues to travel in the desired direction and does not veer away from the intended direction of travel when installing conduit runs and raceways. This alignment is also important when using coupling and connector fittings when extending the offset conduit to another conduit, or when offsetting the conduit into a termination box or other fixed placement fitting.

Another common problem with using such bending tool is time expenditure in the process of performing an offset bend. The three above listed problems all contribute to time expenditures of the person performing an offset bend. Time is also expended in the use of a tape measure for the measuring the offset bends starting points. Time is also expended in using a calculator, basic multiplication on paper, or performing mental calculations. Time is also expended when an offset chart or multiplier legend has to be referenced.

The bending tools of the prior arts do not solve the problems as mentioned above. One approach to partially solving these problems is disclosed in U.S. Pat. No. 4,063,444, issued 20 Dec. 1977, which is incorporated herein by reference, and which provides an adhesive tape measuring device (FIG. 3) that is adhered to the side length of the benders forming head (12) and handle (13). As evident in FIG. 2a, a length of pipe (20) was first inserted through the ring (11) and then manually bent over the head to provide the first bend (21). After making the bend (21), the pipe (20) is rotated through 180 degrees and, at the same time, shifted longitudinally to the position as shown in FIG. 2a, representative approximately of a desired offset measurement. The operator then determines the point of the second bend, to obtain the offset desired, by sighting along the lower edge of the length of pipe (20), at the same time adjusting the exact position of the pipe in the ring (11) until the sight line intersects the exact measurement, indicated on the scale of the marked tape, corresponding to the desired offset. At this instant, holding the pipe and pipe bender in fixed relation, the operator then exerts the necessary force on the handle to make the second bend (23). FIG. 2b shows the offset section of the pipe (24) after the second bend has been accomplished, the amount of the offset being that between the two parallel sections (20 and 24) of the pipe. However, this sighting method is lacking accuracy and the user has to physically orient one's line of eyesight with the adhered tape (13) and the length of pipe (20).

In the above-mentioned system, the user has to physically orient the conduit and complete bender apparatus in such a manner that their line of eyesight is in-line with the imaginary line that one would mentally draw from the desired offset value on the measuring tape to that of the section of pipe from the first bend. It is evident that the user would either have to physically crouch or kneel on the ground or raise the complete bender apparatus and conduit in midair to that of the user's eyesight while standing. This bodily alignment must be maintained while simultaneously adjusting and sliding the conduit lengthwise to the desired height. What is further desired is a way of achieving this line of sight without bodily strain and/or relying on one's judgment as to whether or not the two points are lined up precisely.

Also, in the above-mentioned system, once the user determines the desired placement of conduit in respect to the desired offset measurement, one would then have to return the complete bender apparatus and conduit combination to a normal bending stance. The conduit would then have to be further rotated in the bender head in order to align the first bend to that of the benders forming head prior to making the second bend. Failure to do so would lead to miss-alignment between the two bends. This method further relies on the user's line of sight and personal judgment which can lead to errors (wasted conduit/pipe/tubing) in performing the offset bend. What is additionally desired is a system that can physically align the two bends without solely relying on line of sight and personal judgment.

Also in the above-mentioned system, conduit/pipe/tubing installers may find in necessary to obtain a desired offset measurement for a “top to bottom” type of offset (the distance between the top of the first bend on the conduit to that of the bottom of the second bend on the conduit) instead of the “standard offset” method (distance between the bottom of the conduit on the first bend to that of the bottom of the conduit on the second bend). What is further desired is a precise way to accommodate both types of offset measurements (bottom to bottom of conduit, and bottom to top of conduit) without having to calculate the diameter of the conduit/pipe/tube being used to that of the standard (bottom to bottom) offset measurement.

Generally, conduit benders of the prior art rely on mathematical offset multipliers and/or legends with predetermined distances between bends for specific angles used in the offset forming process.

The purpose of the present invention is to provide a predictive offset measuring system that is easy to operate with little or no training and addresses multiple common problems that are inherent in the process of performing offset bends. The invention will address the following problems: time consumption in performing calculations associated with offset bends, user error when using line of sight methods to align the two bends of an offset, reference point marking of the conduit/pipe/tube that will be formed and installed, user error when determining a line of sight between a flat plane of the conduit/pipe/tube and a specific unit on a measuring device as depicted in U.S. Pat. No. 4,063,444.

The above-mentioned systems may require the use of tape measures and offset calculators to achieve a determination of the offset points of the bends in the pipes. This enables precise offset heights to be determined in addition to arc lengths of any bend. However, this takes time and is prone to operator error. What is desired is a more precise way of achieving the offset heights. What is further desired is a way of achieving desired offset heights without requiring calculations.

One beneficial purpose of the present invention is to provide a bending apparatus, especially for conduit or pipe or tube, and also a bend length-selector for such a bending apparatus which assists, in a simple manner, reducing time consumption in calculation for different offset distances and angles in the bending process and to give the user a physical alignment and a numerical unit value to the bend they are making.

### SUMMARY OF INVENTION

The present invention generally relates to conduit or tube benders for bending Electrical Metal Tubing (EMT) conduit. More particularly, a laser guided conduit or tube bending system that can be used for reducing time consumption in calculations for different offset angles and depths in the bending process and to give the user a physical alignment and a numerical unit value to the bend they are making. The present invention includes a kit of parts including a pipe bender having a curved bending head, and a laser guide. The present invention also includes the laser guide housing and means for holding the laser guide on either the conduit, or a handle of the pipe bender. The present invention further includes a method for bending offsets to metallic conduit using a laser guide and the pipe bender.

The kit of parts for bending a metallic conduit includes a pipe bender having a handle having an end. A bending head attaches to the end of the handle, the bending head having a curve for uniformly guiding metallic conduit during bending. The bending head has a distal end with a conduit retainer for securing the metallic conduit during bending. The laser guide includes a housing and a laser pointer held by the housing.

The laser guide is configured to be removably affixable to the handle for storage and transportation and the laser guide is rapidly removable from the handle for operative attachment to a conduit to facilitate accurate conduit offset bending.

In one embodiment of the invention, the laser guide includes an embedded magnet for removably holding the laser guide on the handle during non-use, and on the metallic conduit during use.

In another embodiment of the invention, the laser guide housing is formed having at least two planar contact surfaces joined along a line. At least two planar contact surfaces define an angle for engaging to a curved external surface of the metallic conduit. Each of the at least two planer surfaces include a magnet for removably holding the laser guide on the handle during non-use, and on a conduit during use.

In an alternate embodiment of the invention, the laser guide is fabricated from two sections that join to hold a magnet between the two sections. The magnet removably holds the laser guide on the handle during non-use and holds the laser guide on the conduit during use. The magnet also holds the two sections together in a removable manner to enable replacement of the magnet. The two sections also include alignment pins to maintain alignment of the two sections, and to inhibit shear shifting of one section from the other section.

In another embodiment of the invention, the laser guide housing is formed having three planar contact surfaces for engaging a curved external surface of the metallic conduit. The magnet has a cuboid shape having a flat side that aligns with one of the planar contact surfaces.

The use of a magnet is preferred; however, it is not necessary. The laser guide in one embodiment of the invention includes a clasp means for selectively holding the laser guide on either a conduit or on the handle of the pipe bender. This clasp means can be used as an alternative to, or in addition to, a magnet. While the clasp means has a variety of shapes disclosed herein, it can simply be a flexible band, or other means of removably securing the laser guide to a conduit or to the handle.

The laser guide can take many shapes in accordance with the present invention to align a laser pointer with the conduit to be bent. In one particular embodiment, the laser guide is for holding a laser in alignment with a metallic conduit having an axis to facilitate bending of the metallic conduit with a pipe bender. The laser guide has a housing defining an internal orifice for receiving a laser pointer. The laser pointer being adapted for aiming laser light in a single direction and is also cylindrical in shape to press fit into the internal orifice defined in the housing.

To achieve alignment on a conduit having a round cross section, the housing has at least two planar contact surfaces joined along a line. The at least two planar contact surfaces define an angle for engaging a curved external surface of the metallic conduit. The line aligns in a direction parallel to an axis defined by the metallic conduit and lies on the surface of the conduit.

Further, the line joining the at least two planar contact surfaces aligns with the laser pointer so that when the laser pointer operates, the laser light parallels with the line joining the planar surfaces of the housing.

Thus, when the housing is affixed to the metallic conduit, the laser light can be directed in a direction parallel to the axis of the metallic conduit.

The laser guide includes a magnet, or a clasp means having a coil spring axially aligned in a direction towards the internal orifice for selectively and removably holding the laser guide on either a conduit or on the handle of the pipe bender. In a variation of the clasp means, the clasp means includes a coil spring and two holding elements hinged together to scissor mount the laser guide on either a conduit or on the handle of the pipe bender.

In a further variation of the clasp means, the clasp means has a coil spring and two holding elements independently attached to opposing sides of the housing of the laser guide, the coil spring biases the two holding elements to squeeze the two holding elements on either a conduit or on the handle of the pipe bender.

In another variation of the invention, the clasp means normally biases the clasp means in a holding orientation, and axial pressure against the clasp means compresses the coil spring and releases the clasp means from the holding orientation. This achieves a quick release of the laser guide from a metallic conduit.

It can be appreciated that the clasp means is optimal for use of the invention with non-ferrous metallic conduits, or metallic conduits that have very little ferrous content.

The present invention includes a method of bending a metallic conduit having an axis. The method includes providing a pipe bender with a handle having an end, a curved bending head attached to the end of handle, the curved bending head includes a distal end with a conduit retainer. The method includes next inserting a metallic conduit into the curved bending head between the retainer and the curved surface. Afterwards the step of attaching a laser guide to the metallic conduit and causing the laser guide to direct laser light at the center of the pipe bender enables proper placement of the initial bend angle and at least one distance with respect to the metallic conduit. Next the metallic conduit can be rotated 180 degrees in the benders shoe to direct laser light to the benders handle to reference a specific offset distance that is relative to a point on the benders handle.

Importantly, the step of attaching the laser guide includes magnetically attaching the laser guide to a metallic conduit. When the laser guide includes two planar surfaces for contacting the conduit and aligning the laser pointer, and the step of attaching includes aligning the planar surfaces with the conduit axis. Preferably, each of the two planar surfaces includes a magnet that magnetically attaches the laser guide to the metallic conduit.

In a variation of the method, the laser guide includes three planar surfaces and the step of attaching includes aligning the three planar surfaces with the conduit axis and using a single magnet to align and attach the three planar surfaces to the conduit. One of the planar surfaces includes a magnet for removably attaching the laser guide in operative alignment with the conduit.

### BRIEF DESCRIPTION OF THE DRAWINGS

The object of the invention may be understood in more detail and more particular descriptions of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows a front view of a kit of parts including a laser guided conduit bender and a laser guiding system magnetically attached thereto.

FIG. 2 is a perspective view of a laser guided conduit bending system with a conduit in accordance with an embodiment of the present invention.

FIG. 3 is a side view of the present invention and a conduit with a first bend.

FIG. 4 is a perspective view of the present invention and a rotation of the conduit after the first bend.

FIG. 5 is a side view of the present invention and a conduit with a second bend.

FIG. 6 is an exploded perspective view of a laser guide made from two sections and having three planar contact surfaces.

FIG. 7 is a bottom perspective view of a laser guide having a housing with two planar contact surfaces.

FIG. 8 is a front view of a laser guide having a scissor clamp for holding the laser guide.

FIG. 9 is a front view of a laser guide having a scissor clamp holding a conduit.

FIG. 10 is a front view of a laser guide having a pressure clamp for holding the laser guide.

FIG. 11 is a front view of a laser guide having a pressure clamp holding a conduit.

FIG. 12 is a front view of a laser guide having a hook clamp.

FIG. 13 is a front view of a laser guide having a hook clamp holding a conduit.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art. In an embodiment of the present invention, the system comprises a curved bending head or shoe which receives the conduit or pipe to be bent and it is attached to an elongated handle. The measuring system is incorporated onto the benders handle and shoe consists of measuring units (metric or standard) and a centerline that is aligned with the front facing side of the entire bender handle and shoe. Linear measurements are provided on the handle part and angular measurements are provided on the shoe part. Further, the system has a laser guide which is clamped or adhered with the conduit. The laser guide aligns to the length of conduit to form a parallelogram from the laser line to the running length of the conduit and points on the measuring system provided on handle to extract exact amount on length required for bend.

In another embodiment of the present invention, the measuring system and laser guide interact with each other to give the user a physical alignment and a numerical unit value to the bend they are making. A proper positional placement of the bend end point can be marked on the handle measuring system by means of the laser guide to assure the right measurement required for the bend edge on the conduit or pipe.

In another embodiment of the present invention, the curved bending head or shoe and the elongated handle are made up of material such as, but not limited to cast iron, carbon steel, etc. and the measuring system for curved bending head or shoe and elongated handle can be adhered separately with them.

In one advantage of the present invention, the system drastically reduces the amount of math and measuring associated with making field bends with a hand conduit bender.

In another advantage of the present invention is no marking of the conduit is required and further reduces the time consuming in calculation such as math multipliers for different offset angle and depths.

In another advantage of the present invention is the measuring system which is incorporated onto the hand benders length of handle and portions of the bender shoe. The measuring system will also consist of a centerline that will be used for aligning bends made with the hand bender, reducing “doglegs” that are a common problem in field bending.

These and other aspects are discussed in detail below. The foregoing information and the following detailed description include illustrative examples of various aspects and implementations and provide an overview for understanding the claimed aspects and implementations.

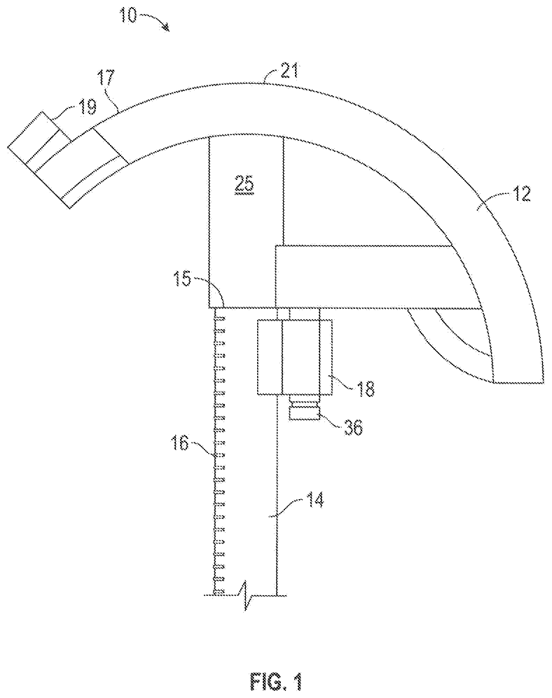

FIG. 1 shows a conduit bending system generally referred to with the reference numeral 10, which is also referred to as a kit of parts. The kit of parts 10 for bending a metallic conduit includes a pipe bender 25 including a handle 14 and an end 15. The pipe bender 25 is manually operated with no external electrical power supplied to effectuate conduit bending in one embodiment of the invention. It can be appreciated that the present invention can be adapted for conduit bending in a factory environment with powered conduit benders in various embodiments of the invention.

A bending head 12 attaches to the end 15 of the handle 14, the bending head 15 having a curve 21 for uniformly guiding conduit during bending. The bending head 15 has a distal end 17 with a conduit retainer 19 for securing the metallic conduit during bending. The laser guide 18 includes a housing and a laser pointer 36 held by the housing.

The laser guide 18 is configured to be removably affixed to the handle for storage and transportation and the laser guide 18 is rapidly removable from the handle 14 for operative attachment to a conduit to facilitate accurate conduit bending. The handle 14 has distance markings along the length of the handle to enable the handle 14 and the laser guide 18 to cooperate to precisely measure offset bends in a conduit when the laser guide 18 mounts on a conduit during bending.

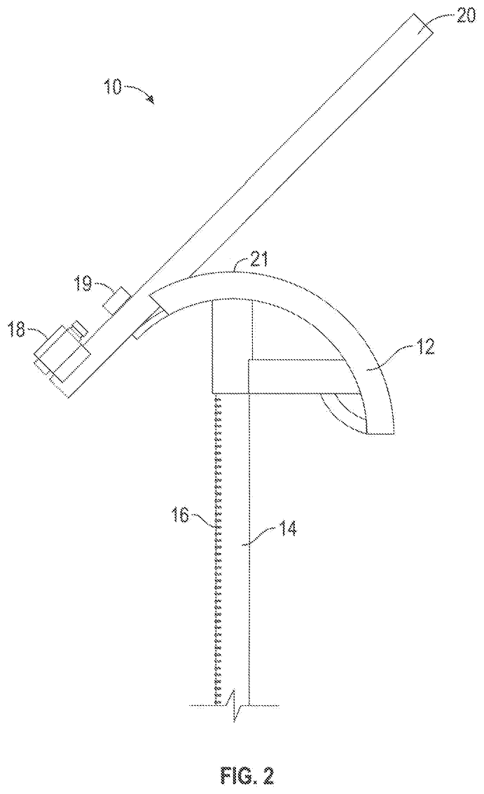

FIG. 2 shows the curved bending head 12 receiving the conduit 20 to be bent. The handle 14 includes measurement indicia 16 is incorporated onto the handle 14. In various embodiments, the measurement indicia 16 are adhered, etched, cut, engraved, cast, or otherwise marked on the handle 14.

For a first bend, the laser guide 18 is removed from the handle 14 as shown in FIG. 1 and attaches to one end of the conduit 20. The conduit 20 lies on the curve of the bending head 12 with a portion secured between the bending head 12 and the conduit retainer 19

The laser guide 18 aligns to the length of the conduit 20 to form a parallelogram from the laser line to the running length of the conduit 20 and points on the measuring system 16 provided on handle 14 to extract exact amount on length required for bend.

In the laser guided conduit bending system 10, the measurement indicia 16 and laser guide 18 interact with each other to give the user a physical alignment and a numerical unit value to the bend they are making. A proper positional placement of the bend end point can be marked on measuring system 16 of the handle 14 by the laser pointer 18 to assure the right measurement required for the bend edge on the conduit or pipe 20.

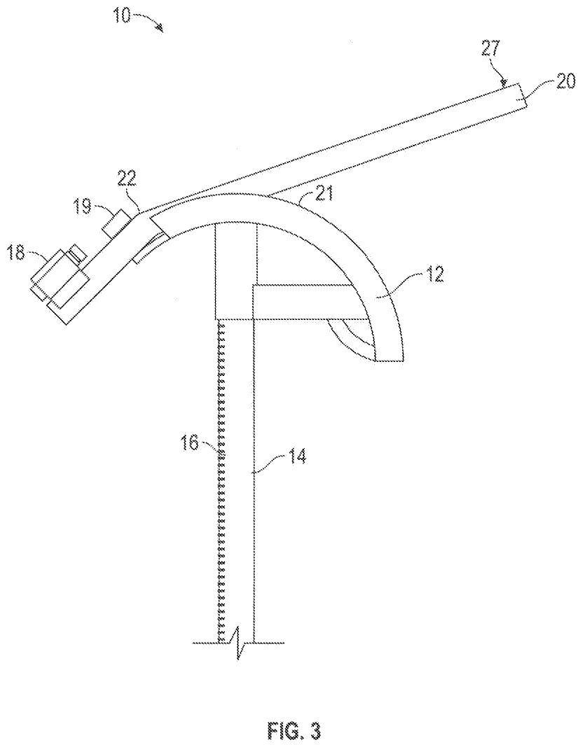

FIG. 3 shows user-initiated force in the direction of the arrow 27 bends the conduit 22 near the conduit retainer 19 and along the curve 21 of the bending head 12. FIG. 3 shows a first bend in the conduit 22.

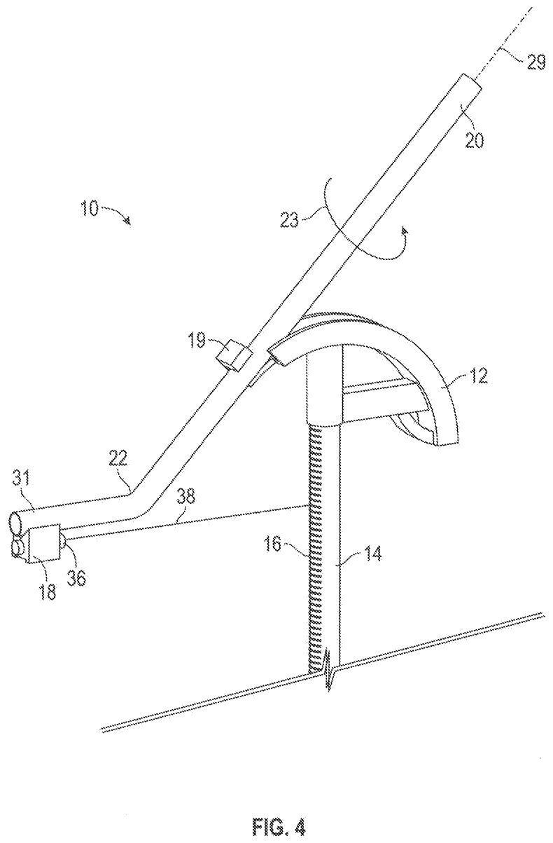

FIG. 4 shows the conduit 20 rotated in the direction of the arrow 23 to align the laser guide 18 and laser pointer 36 to direct laser light 38 at the measurement indicia 16 to instantly determine an offset bend measurement between the first bend demonstrated in FIG. 3 and a second bend. The conduit 20 slides along its axis 29 past the conduit retainer 19 until the laser 38 points at a desired location on the measurement indicia 16. The measurement indicia can determine, in cooperation with the laser light 38 a bottom to bottom distance between bends in the conduit, or a top to bottom distance. The distance between the laser light 38 and the bottom of the end 31 of the conduit 20 is accounted for by the measurement indicia 16.

In one embodiment, the user rotates the conduits 20 by 180 degree so that a proper positional placement of the bend end point can be marked on the handle measuring system 16 by means of the laser guide 18 to assure the right measurement required for the bend edge on the conduit 20.

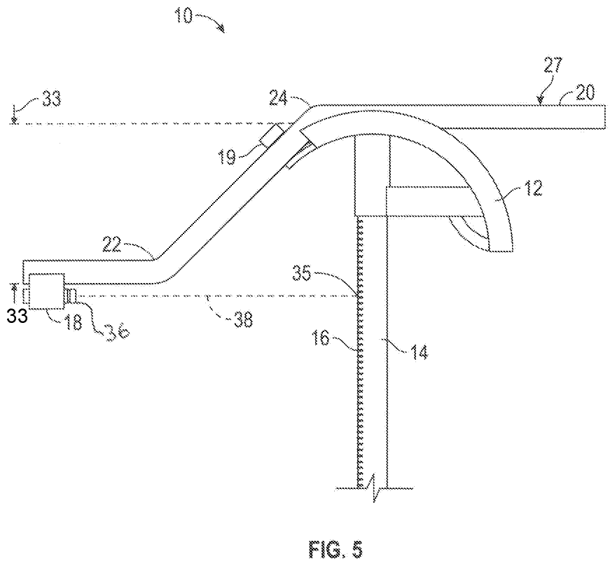

FIG. 5 shows the conduit 20 having a first bend 22 and a second bend 24. The second bend 24 is achieved by user generated force in the direction of the arrow 27. The laser guide 18 remains adhered or affixed at one end of the conduit 20. The second bend 24 on the conduit 20 is made by the user at pre-determined angle and length using the kit of parts 10.

The laser guide 18 directs laser light 38 to the measuring system 16. The measuring system has one or more graduated markings extending along the length of the handle 15. In one embodiment two rows of graduated markings indicate the distance 33 between the bottom of the conduit 20 at one end of the conduit 20 and the bottom of the other end of the conduit 20. This distance 33 is the bottom to bottom distance. The graduated markings are calibrated to accommodate any offset of the laser guide 18 and the laser light 38.

The distance 33 between the bottom of the conduit 20 near the conduit retainer 19 and the laser guide 18 is a bottom to bottom measurement of the offset bend of the conduit 20. This measurement is expressed by the measurement indicia 16 by the particular marking 35.

As shown the conduit 20 has an offset bend due to the bends 22 and 24. The offset distance 33 is indicated by the particular marking 35 of the measurement indicia. A tape measure is not required to achieve a precise offset bend in the conduit 20.

In similar manner, a user can make the number of bends without any calculation such as math multipliers for different offset angle and depths in very less time.

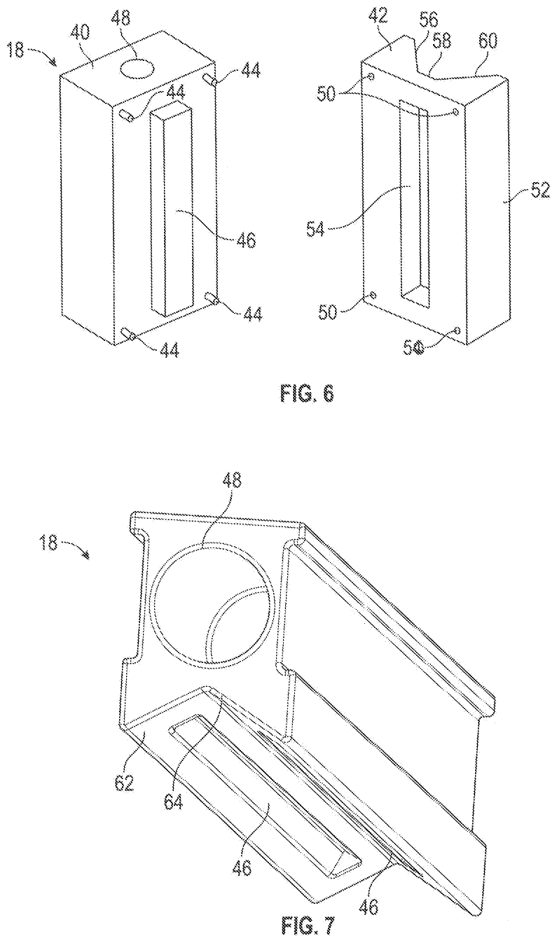

FIG. 6 is an exploded perspective view of an embodiment of the laser guide 18. The laser guide has a first section 40 and a second section 52. The section 40 defines an annular bore 40 for receiving a laser pointer having a cylindrical shape in a press fit arrangement. The section 40 has four corner posts 44 on a mating surface for aligning the section 40 with the section 52. The section 40 includes a magnet 46 affixed to the mating surface.

The section 52 includes four corner holes 50 defined on a mating surface of the section 52 that mate with the posts 44 of the section 40. The section 52 further includes an opening 54 on the mating surface to enable the magnet 46 to extend through the section 52 to adhere the laser guide 18 with direct magnetic contact with a conduit. The cooperation of the magnet 46, the posts 44 and the hoes 50 maintain the laser guide 18 in a fixed press fit interconnection and hold the bore 48 in a fixed alignment.

The section 52 includes three contact surfaces 56, 58 and 60, which are rectangular shaped planar surface that are able to simultaneously contact a conduit. The contact surface 58 includes a portion defining a part of the opening 54 to enable direct contact between the magnet 46 and a conduit.

FIG. 7 is a bottom perspective view of a laser guide 18 having housing has two planar contact surfaces 62 and 64. Each of the contact surfaces 62 and 64 includes a magnet 46 mounted on each of the two planar contact surfaces 62 and 64. The magnets 46 enable direct contact with a conduit to hold the laser guide 18 on a metallic conduit during use and for holding the laser guide on the pipe bender during non-use. The contact surfaces 62 and 64 and the magnets 46 cooperate to align, and maintain alignment of the laser guide 18 on a conduit, particularly aligning the bore 48 in operative alignment with a conduit bender when a laser pointer is mounted therein.

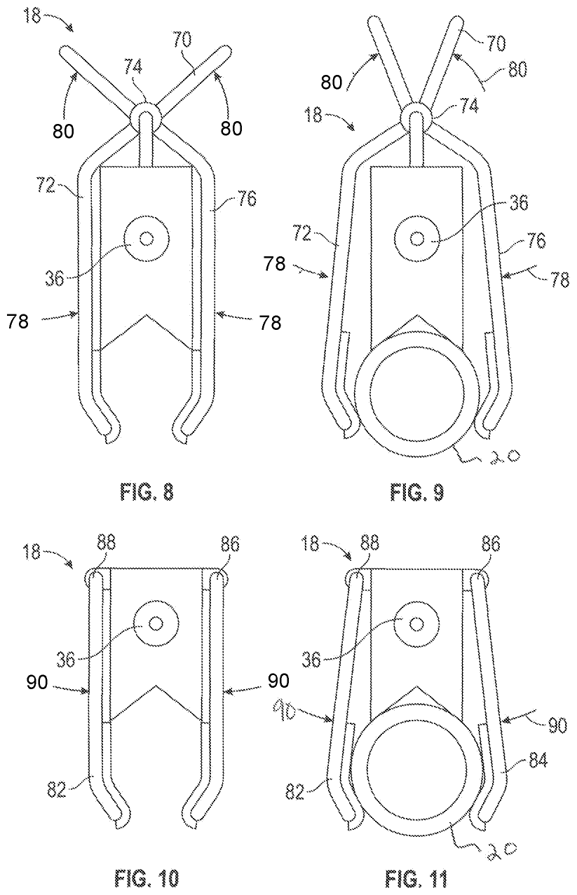

FIG. 8 and FIG. 9 are each a front view of a laser guide having a scissor clamp 70 for holding the laser pointer 36. The scissor clamp 70 includes a hinge 74 attaching two arms 72 and 76 in a scissor arrangement. The hinge 74 attaches to the housing of the laser guide 18. FIG. 9 particularly shows that pressure on the scissor clamp 70 in the direction of the arrows 80 opens the arms 72 and 76 to enable attachment of the laser guide 18 on a conduit 20. Release of the pressure in the direction of the arrows 80 enables the arms 72 and 76 to squeeze the conduit 20 in the direction of the arrows 78.

FIG. 9 and FIG. 10 are front views of a laser guide 18 having a pressure clamp holding a conduit 20. The pressure clamps have two arms 82 and 84, which attach to the housing of the laser guide 18 with hinges 88 and 86. The arms 82 and 84 operate independently. The hinges 88 and 86 bias the arms 82 and 84, respectively, to squeeze the conduit 20 in the direction of the arrows 90 of FIG. 11.

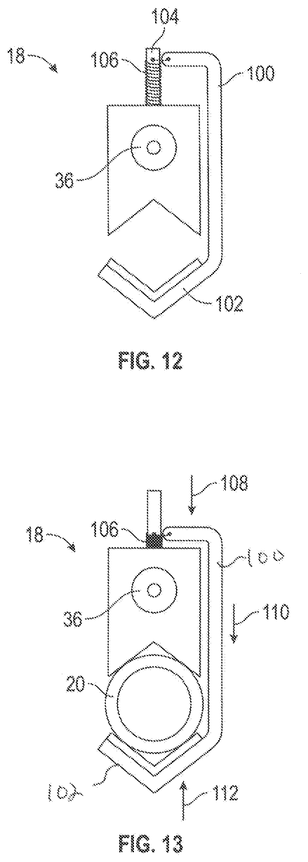

FIG. 12 and FIG. 13 are front views of a laser guide 18 having a hook clamp 100. The hook clamps 100 includes a compressive coil spring 106 mounted on the housing of the laser guide 18 in an axial direction. Movement of the hook clamp 100 in the direction of the arrow 110 compresses the coil spring 106 in the direction of the arrow 108 and enables insertion of the conduit 20 within the hook 102. The hook 102 holds the conduit 20 upon release of the pressure in the direction of the arrows 108 and 110 so that pressure in the direction of the arrow 112 holds the conduit 20 and aligns the laser pointer 36 coaxially with the conduit 20.

The housing 30 is removably attachable to the measuring system 16 as shown in FIG. 1. Preferably, the measuring system 16 is a rigid handle having a ruler defined thereon. The housing 30 removably attaches to the measuring system for storage, transport, and thus, convenience. The housing 30 is removed and place on a pipe 20 to be bent (see FIG. 2) during operation.

During operation the housing 30 holds the laser device 36, which projects a laser line 38 (FIG. 1) to the measuring system 16 so that precise bends can be directed to the pipe 20 by manipulation of the pipe 20 when it is held by the conduit bending system 10.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A kit of parts for bending a metallic conduit comprising:
a pipe bender having a handle having an end;
a bending head attached to the end of the handle, the bending head having a curve for uniformly guiding metallic conduit during bending;
the bending head having a distal end with a conduit retainer for securing the metallic conduit during bending; and
a laser guide including a housing and a laser pointer, the laser guide being configured to be removably affixable to the handle for storage and transportation, the laser guide being rapidly removable from the handle for operative attachment to a conduit to facilitate accurate conduit bending.

2. The kit of parts as set forth in claim 1, wherein the laser guide includes an embedded magnet for removably holding the laser guide on the handle during non-use, and on the metallic conduit during use.

3. The kit of parts as set forth in claim 1, wherein the laser guide housing is formed having at least two planar contact surfaces joined along a line, the at least two planar contact surfaces define an angle for engaging a curved external surface of the metallic conduit; each of the at least two planer surfaces include a magnet for removably holding the laser guide on the handle during non-use, and on a conduit during use.

4. The kit of parts as set forth in claim 1, wherein the laser guide is fabricated from two sections that join to hold a magnet between the two sections, the magnet removably holds the laser guide on the handle during non-use and holds the laser guide on the conduit during use.

5. The kit of parts as set forth in claim 5, wherein the laser guide housing is formed having three planar contact surfaces for engaging a curved external surface of the metallic conduit; the magnet has a cuboid shape having a flat side that aligns with one of the planar contact surfaces.

6. The kit of parts as set forth in claim 1, wherein the laser guide includes a clasp means for selectively holding the laser guide on either a conduit or on the handle of the pipe bender.

7. A laser guide for holding a laser in alignment with a metallic conduit having an axis to facilitate bending of the metallic conduit with a pipe bender, comprising:
a housing defining an internal orifice for receiving a laser pointer, the laser pointer being adapted for aiming laser light in a single direction;
the housing having at least two planar contact surfaces joined along a line, the at least two planar contact surfaces define an angle for engaging a curved external surface of the metallic conduit;
the line joining the at least two planar contact surfaces aligns with the laser pointer so that when the laser pointer operates, the laser light parallels with the line joining the planar surfaces of the housing, and
whereby when the housing is affixed to the metallic conduit, the laser light is directed in a direction parallel to the axis of the metallic conduit.

8. The laser guide as set forth in claim 7, wherein the housing has three planar contact surfaces and a cuboid shaped magnet aligned along one of the three planar contact surfaces.

9. The laser guide as set forth in claim 7, wherein the housing has two planar contact surfaces, and a magnet mounted on each of the two planar contact surfaces for holding the laser guide on a metallic conduit during use and for holding the laser guide on the pipe bender during non-use.

10. The laser guide as set forth in claim 7, wherein the laser guide includes a clasp means having a coil spring axially aligned in a direction towards the internal orifice for selectively and removably holding the laser guide on either a conduit or on the handle of the pipe bender.

11. The laser guide as set forth in claim 7, wherein the laser guide includes a clasp means having a coil spring and two holding elements hinged together to scissor mount the laser guide on either a conduit or on the handle of the pipe bender.

12. The laser guide as set forth in claim 7, wherein the laser guide includes a clasp means having a coil spring and two holding elements independently attached to the housing of the laser guide, the coil spring biases the two holding elements to squeeze the two holding elements on either a conduit or on the handle of the pipe bender.

13. The laser guide as set forth in claim 7, wherein the laser guide includes a clasp means for selectively and removably holding the laser guide on either a conduit or on the handle of the pipe bender.

14. The laser guide as set forth in claim 9, wherein the clasp means normally biases the clasp means in a holding orientation, and axial pressure against the clasp means compresses the coil spring and releases the clasp means from the holding orientation.

15. A method of bending a metallic conduit having an axis, comprising:
providing a pipe bender with a handle having an end, a curved bending head attached to the end of handle, the curved bending head includes a distal end with a conduit retainer;
inserting a metallic conduit onto the curved bending head between the retainer and the curved surface;
attaching a laser guide to the metallic conduit and causing the laser guide to direct laser light at the handle of the pipe bender to enable measurement of at least one distance with respect to the metallic conduit.

16. The method of bending a metallic conduit as set forth in claim 14, wherein the step of attaching includes magnetically attaching.

17. The method of bending a metallic conduit as set forth in claim 14, wherein the laser guide includes two planar surfaces and the step of attaching includes aligning the planar surfaces with the conduit axis.

18. The method of bending a metallic conduit as set forth in claim 16, wherein each of the two planar surfaces magnetically attaches to the magnetic conduit.

19. The method of bending a metallic conduit as set forth in claim 14, wherein the laser guide includes three planar surfaces and the step of attaching includes aligning the planar surfaces with the conduit axis.

20. The method of bending a metallic conduit as set forth in claim 18, wherein one of the planar surfaces includes a magnet for removably attaching the laser guide in operative alignment with the conduit.
